(19) United States
(12) Patent Application Publication
(10) Pub. No.: US 2014/0371043 A1
(43) Pub. Date: Dec. 18, 2014

(54) TRANSMISSION DEVICE FOR EMBOSSING ROLLERS

(71) Applicant: FUTURA S.P.A., Capannori (LU)

(72) Inventor: Fabio Perini, Viareggio (IT)

(73) Assignee: Futura S.P.A., Capannori (IT)

(21) Appl. No.: 14/373,455

(22) PCT Filed: Mar. 18, 2013
(86) PCT No.: PCT/IT2013/000078

§ 371 Date: Jul. 21, 2014

(30) Foreign Application Priority Data
Mar. 21, 2012 (IT) FI2012A000061

(51) Int. Cl. B44B 5/02

(52) U.S. Cl. CPC B44B 5/026
USPC 492/15

(57) ABSTRACT

Transmission device for embossing rollers, comprising a pin (31) destined to be axially inserted into one end (100) of an embossing roller (1), the said pin (31) being motorized to drag the embossing roller (1) in rotation when it is inserted in said end (100). The said pin (31) is supported by elastic means (M1, M2,G) which allow its automatic alignment with a longitudinal axis (r) of the said end (100) of the embossing roller (1) during insertion of the pin (31) into the same end (100).

### DESCRIPTION

The present invention relates to a transmission device for embossing rollers.

It is known that embossing consists in a mechanical process used to impress a plurality of projections on yieldable materials, such as webs or “plies” of paper. For this purpose, the material to be embossed is made to pass through a calender comprising a steel roll provided with substantially punctiform reliefs and an opposed smooth rubber roller. The steel roll is connected to respective handling means while the rubber roll is idle on the respective support axle. The embossing results from the passage of the material between the rollers of the calender, where a compression of the material, without perforation, takes place in correspondence with the reliefs of the steel roll. This operation is generally performed on a plurality of single plies, which are then joined together by gluing and then are wound on tubular cardboard cores to form logs in machines commonly called “rewinders”.

It is also known that the effect of the embossing on the paper webs is closely related to the surface characteristics of the embossing rollers, or to the arrangement and dimensions of the above-mentioned reliefs. The embossing rolls often have designs or patterns and it can be necessary to replace them even on a daily frequency to vary designs or patterns on the paper material subjected to embossing. In order to vary the type of embossing according to specific production needs, it is possible to replace one or more embossing rollers with others provided with differently shaped and/or dimensioned reliefs. For this purpose, it is necessary to disconnect these rollers from the respective driving means.

The main purpose of the present invention is to propose a transmission device for embossing rolls which allows to carry out the change of the rollers in a particularly simple and safe way from the operative point of view and to enable a more efficient automation of the connection between the embossing and the respective drive member.

This result is achieved, according to the present invention, by adopting the idea of making an apparatus having the features indicated in claim 1. Other features of the present invention are the subject of the dependent claims.

Thanks to the present invention, it is possible to replace the embossing rollers in a simple, reliable and safe way, without the risk of compromising the structural integrity of the rollers or that of the structures servicing the rollers. Moreover, thanks to the present invention it is possible to connect the axis of the embossing rollers with the axis of the corresponding drive members without requiring any manual intervention for the alignment of said axes and then automatically compensating the possible alignment errors.

These and other advantages and features of the present invention will be best understood by anyone skilled in the art thanks to the following description and to the attached drawings, given by way of example but not to be considered in a limiting sense, in which:

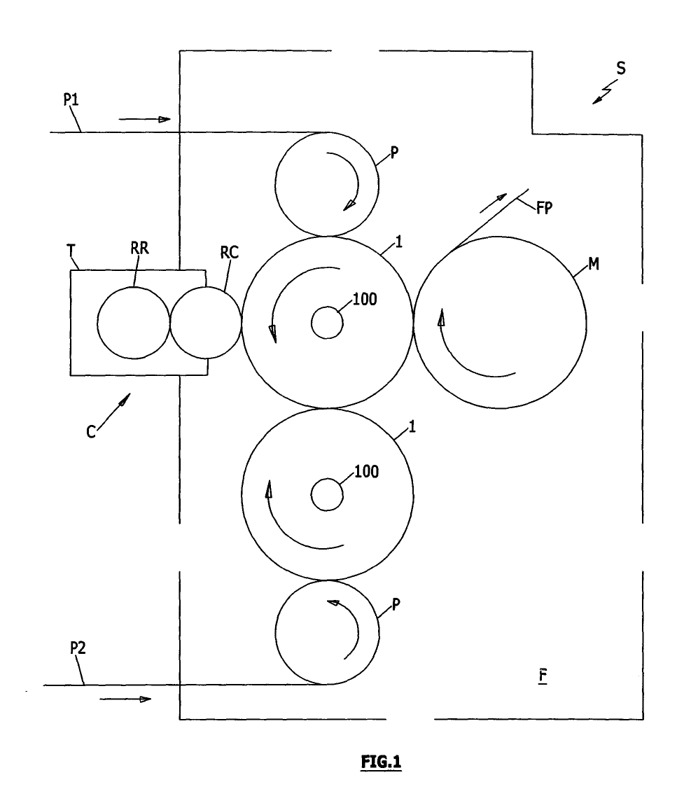

FIG. 1 is a schematic side view of an embossing unit to which can be applied a transmission device in accordance with the present invention;

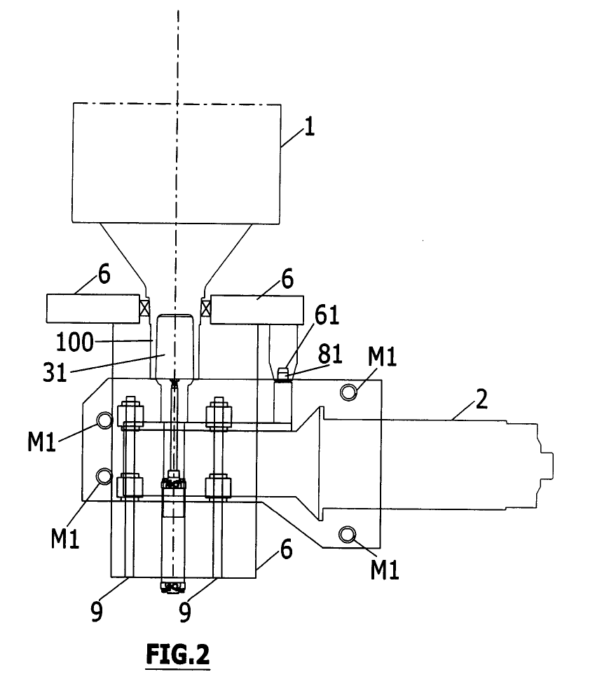

FIG. 2 is a schematic plan view, in transparency, of an embosser provided with a transmission device in accordance with the present invention at the motor side of an embossing roller, in a configuration of transmission engaged;

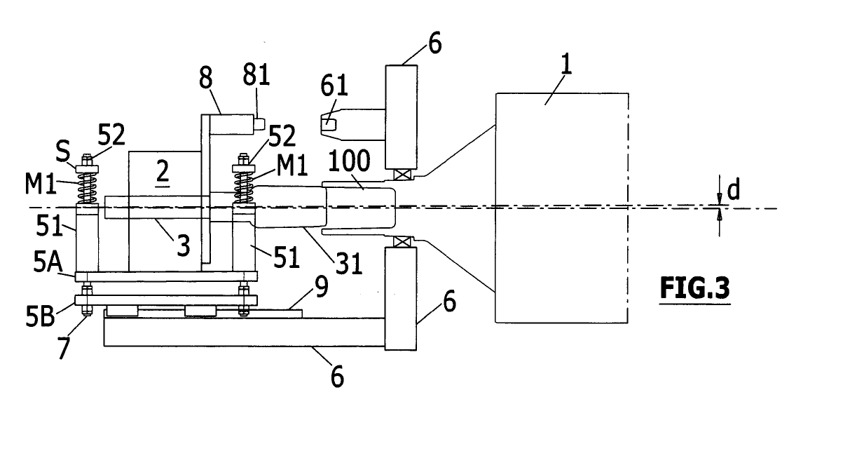

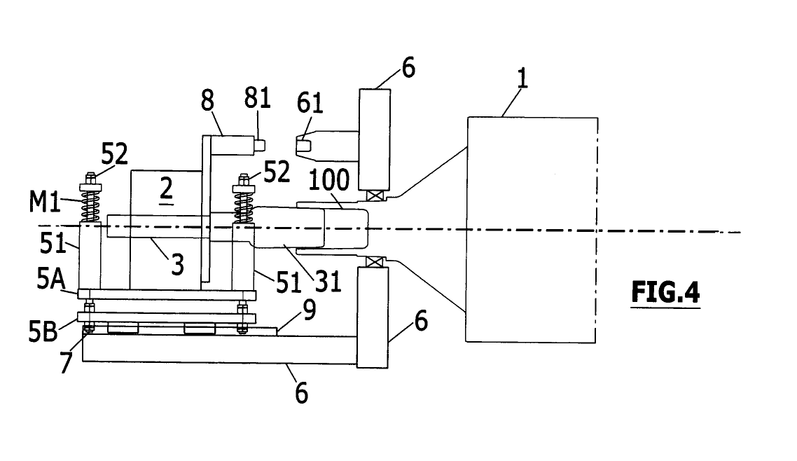

FIGS. 3, 4 and 5 are schematic side views of the assembly shown in FIG. 2 in three different configurations;

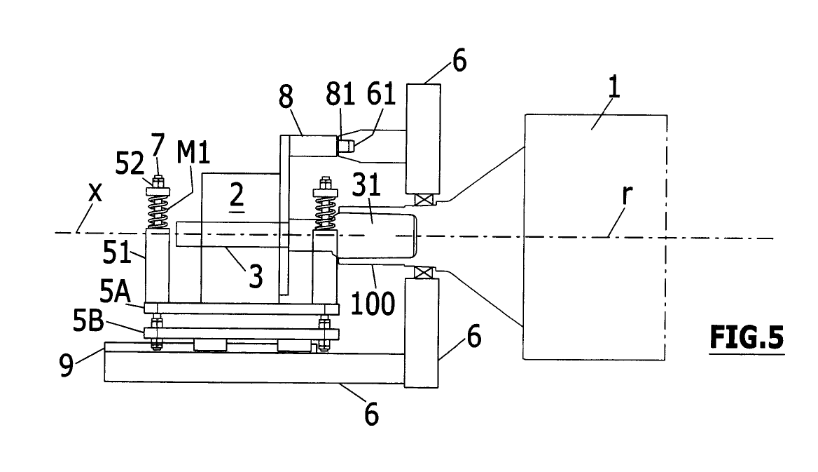

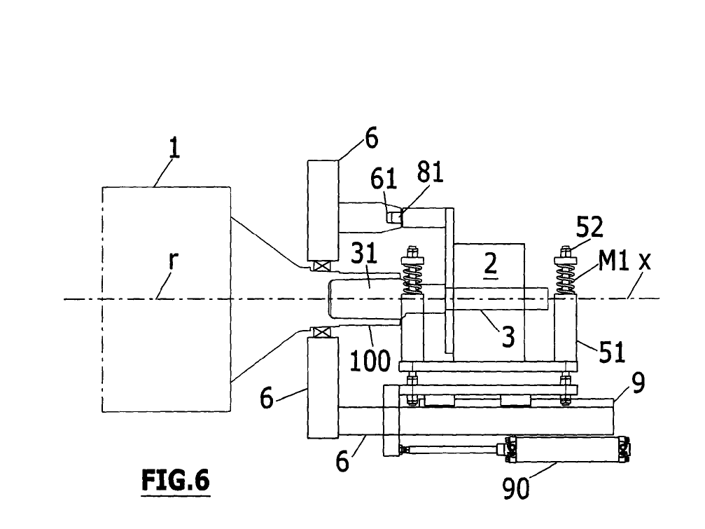

FIG. 6 shows the group of FIG. 5 seen from the opposite side;

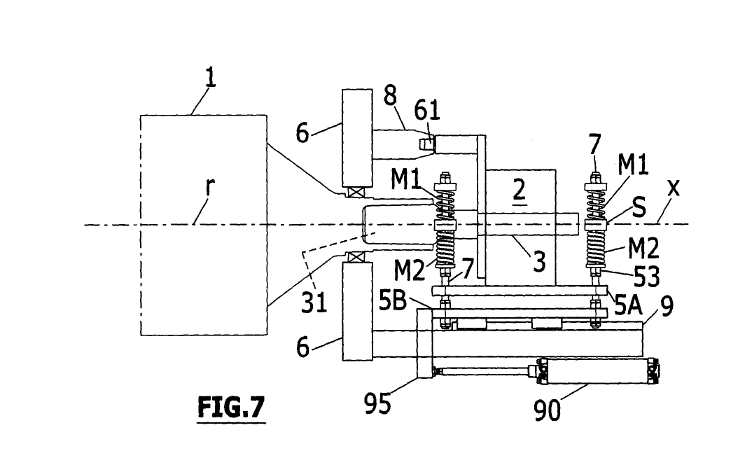

FIG. 7 shows the same view of FIG. 6 in which the columns (51) are not illustrated to the arrangement of the springs (M1) and (M2) make better visible;

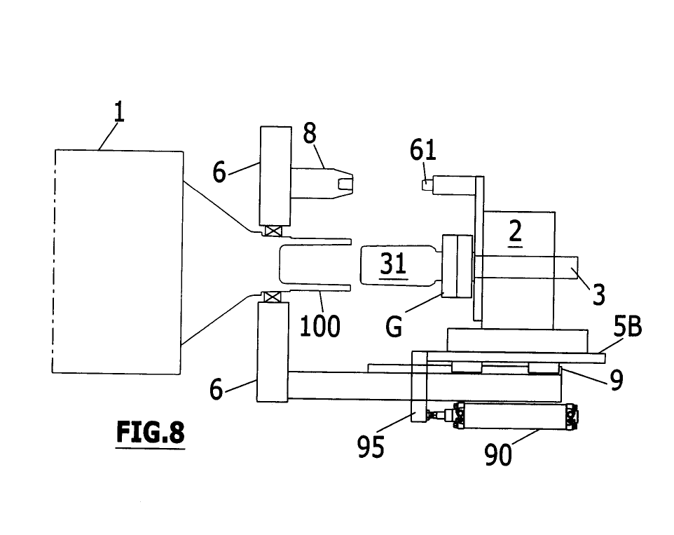

FIG. 8 is a view similar to that of FIG. 7 but referring to a further embodiment of a device in accordance with the present invention.

A device in accordance with the present invention is applicable to embossing units comprising at least one embossing roller (1) with a motor side that has a recess (100) shaped to be axially engaged by a hydraulically expandable drive pin (31). The drive expandable pin (31) is mounted on the shaft (3) connected to a drive member (2) that permits its rotation about the respective longitudinal axis (x) with a predetermined angular speed. Therefore, the drive torque is transmitted by the drive member (2) to the embossing roller (1) through the shaft (3) and the drive pin (31) once the latter is inserted and aligned axially with the recess (100) of the roller (1).

Conversely, the drive member (2) and the embossing roller (1) are decoupled by extracting the drive pin (31) from the recess (100). The hydraulic expansion of the drive pin (31) is actuated after the pin has been inserted in the recess (100) and before operating the drive member (2). Conversely, for disconnecting the roller (1) by the drive member (2), the drive pin (31) is contracted for its removal from the recess (100).

For example, the embossing unit can be of the type shown in FIG. 1, wherein a fixed structure (S) supports two embossing rollers (1) whose respective axes are horizontal, that is, oriented orthogonally to the sides (F) of same structure, arranged one above the other. The two embossing rollers (1) cooperate each with a corresponding pressure roller (P) normally coated with an elastically yielding material, for example rubber. On one of the embossing rollers (1), the upper one in FIG. 1, acts a sizing unit (C) comprising a tank of glue (T), an anilox roller (RR) which picks up the glue from the tank (T), and a cliché roll that receives the glue from the anilox roll (RR) and applies it on a first paper ply or web (P1). The latter is already embossed since it has already passed between the roller (1) and the overlying presser roller (7). A second ply (P2) is embossed by the lower roller (1) in cooperation with the corresponding pressure roller (P) and is coupled permanently with the first layer (P1) thanks to the pressure exerted by a “marrying roll” (M) acting on the upper roller (1) on the opposite side with respect to the sizing unit (C). The finished product, consisting of the plies (P1) and (P2) embossed and glued together, is indicated by the reference “FP”.

According to the example shown in FIGS. 2-6 of the attached drawings, the drive member (2) is fixed on a base (5A). The said base (5A) is a plate of predetermined thickness with a square or rectangular shape in plan view, on whose face facing upwards, i.e. on the face on which the drive member (2) is located, are fixed four columns (51). Each column (51), which consists of a tubular body of predetermined height and thickness, is fixed in correspondence of a vertex of the base (5A). Inside each column (51) there is coaxially fixed, at a predetermined height, by means of a transverse pin not visible in the drawings, a cylindrical sleeve (S) of predetermined length, whose upper and lower bases support the ends of two springs (M1, M2). More in particular, the lower base of the spring (M1) rests on the upper base of the sleeve (S); the upper base of the spring (M2) rests on the lower base of the sleeve (S). The two springs (M1, M2) and the sleeve (S) are coaxial with each other and are crossed by a rod (7) of predetermined diameter having each end threaded for a predefined length. The sleeve (S) has a hole coaxial thereto of sufficient diameter to be apt to slide freely on the rod (7). The sleeve (S) is maintained on the rod (7), between the springs (M1, M2), by a stop (52) screwed onto the upper end of the rod (7) and, at its lower side, by means of an adjusting nut (53) screwed the lower end of the rod (7). The springs (M1, M2) are preloaded by means of the adjusting nut (53). In practice, each sleeve (S) lies between the upper spring (M1) and the lower spring (M2) within the corresponding column (51). The lower end of each rod (7) crosses the base (5A) and is fixed on an underlying plate (5B). The latter is mounted on guides (9) so as to be able to slide for a run of predetermined length, horizontally, from and to the embossing roller (1). The guides (9) are integral with a fixed frame (6) to which are bound also the ends of the embossing roller (1). The base (5A) has four holes each of which has a diameter sufficient to enable the corresponding rod (7) to slide inside it. In this way, the upper end of the upper spring (M1) and the lower end of the lower spring (M2) are fixed relative to the plate (5B), and then also fixed relative to the frame (6). If a force is applied vertically downwards onto the base (5A), the four lower springs (M2) are compressed through the four columns (51) and the corresponding sleeves (S), for a length proportionate to the force applied. Conversely, a force applied to the movable base (5A) in the sense that pushes it upward, compresses the upper springs (M1) of a length proportionate to the same force. Therefore, the base (5A), when subject to a vertical force applied to it, moves in such a way that the upper springs (M1) or the lower springs (M2) are compressed proportionally to the same force.

The group formed by the motor (2), i.e. the drive member, by the plate (5A) and by the plate (5B) can be moved to and from the roller (1) by means of an actuator with horizontal axis (90) that has the mantle secured to the frame (6) and the stem connected with an appendix (95) of the plate (5B). The extension of the actuator stem (90) determines the approach of the plate (5B) to the embossing roller (1), and then the movement of the motor (2) and the drive pin (31) towards the embossing roller (1). Vice versa, the retraction of said actuator stem implies the removal or disconnection of the driving unit (2, 31) from the roller (1).

The connection between the roller (1) and the driving unit (2, 31) is obtained by approaching the driving unit (2, 31) to the roller (1) to make sure that the pin (31) fits into the hollow end (100) of the roller (1), after which the pin (31) is expanded.

Conversely, to disengage the transmission thus realized, the driving unit (2, 31) is moved away from the roller (1) after contracting the pin (31).

During the connection between the expanding pin (31) and the recess (100), in the case in which the axis (x) of the shaft (3) is misaligned with respect to the axis (r) of the embossing roller (1)—condition schematically indicated by reference “d” in FIG. 3—the contact that takes place between the expanding pin (31) and the recess (100) of the embossing roller (1) gives rise to a force that is transmitted, through the shaft (3) and the driving member (2), to the base (5A). The latter, therefore, thanks to the presence of the springs (M1, M2) moves relative to the lower plate (5B), ie with respect to the frame (6) and the roller (1) which is bound to the same frame. This movement of the base (5A) induced by misalignment (d) takes place until the shaft (3) is not aligned with the embossing roller (1). In other words, thanks to the compensation system described above, the alignment between the axes of the shaft (3) and of the embossing roller (1) takes place automatically during their connection, without requiring any external manual intervention. In fact, the elastic connection between the pin (31) and the frame (6), realized by means of the springs (M1, M2) in the example described above, allows the axis (x) of the group (2, 31) to orient practically according to any direction in space.

In the disconnected transmission configuration, in order to pre-align as much as possible the axes of the shaft (3) and of the embossing roller (1), the adjusting nuts (53) are screwed or unscrewed on the corresponding rods (7) so to raise or lower the axis of the shaft (3) relative to the axis of the roller (1).

In the final configuration of connection between the expandable drive pin (31) and the embossing roller (1), configuration schematically illustrated in FIG. 5, in order to avoid that the mobile base (5A) oscillates due to the torque transmitted by the drive member (2) to the embossing roller (1), it is used a reaction bar (8) integral with the same drive member (2). The front appendix (81) of the reaction bar (8) being inserted in a slot (61) of the frame (6) makes it integral with the base (5A) to the frame (6). This condition occurs, obviously, when the pin (31) is completely inserted into the recessed end (100) of the roller (1), that is, when the movement of the plate (5A) induced by misalignment (d) is no longer required. It goes without saying that the mutual orientation and dimensions of the appendix (81) of the reaction bar (8) and of the corresponding surface with the recess (61) of the frame (6) are suitably chosen so as to ensure that the base (5A) is integral with the frame (6) only when the pin (31) is fully inserted into the recessed end (100) of the embossing roller (1).

A further example of embodiment of a device in accordance with the present invention, shown in FIG. 8, includes the use of a lamellar joint (G) which connects the motor shaft (3) to the expanding pin (31). In this case, the drive member (2) is directly connected on the slide (5B) thanks to which it can move for a predetermined run in the sense that it approaches or departs from the embossing roller (1). In this way, in the case in which the expanding pin (31) is misaligned with the recess (100), during their mating, the contact between the corresponding lateral surfaces gives rise to a transverse force on the shaft (3). This force causes, thanks to the lamellar joint (G), a vertical displacement of the axis of the expanding pin (31) relative to that of the shaft (3), up to reach an alignment of the same expanding pin (31) with the recess (100).

In both the examples described, the said pin (31) is supported by elastic means (M1, M2, G) which allow its automatic alignment with a longitudinal axis (r) of said end (100) of the embossing roller (1) during insertion of the pin (31) in the same end (100).

In practice, the details of execution may vary in any equivalent way as in the shape, size, nature, type and arrangement of the elements indicated, without leaving the scope of the adopted solution and thus remaining within the limits of the protection granted to the present patent.

1. A transmission device for embossing rollers, the transmission device comprising:
a pin destined to be axially inserted into one end of an embossing roller, said pin being motorized to drag the embossing roller in rotation when said pin is inserted in said end, said pin being supported by elastic means for automatically aligning said pin with a longitudinal axis said end of the embossing roller during insertion of the pin into the end of the embossing roller.

2. A transmission device according to claim 1, wherein said pin is a hydraulically expanding pin.

3. A transmission device according to claim 1, wherein said elastic means comprises a lamellar joint disposed between the pin and a corresponding motor that is movable from and towards said end of the embossing roller.

4. A transmission device according to claim 1, wherein said elastic means comprises springs which allow a base to move in height in order to align said pin with said end, said base being mounted on guides so as to be able to slide horizontally, on command, for a run of predetermined length, wherein said base distances or approaches said pin to said end respectively so as to remove or make a connection between said pin and said end, and said pin comprising an end of a shaft driven by a motor fixed on said base.

5. A transmission device according to claim 1, wherein said end is hollow.

6. A transmission device according to claim 2, wherein said end is hollow.
